(19) United States
(12) Patent Application Publication
(10) Pub. No.: US 2025/0381515 A1
(43) Pub. Date: Dec. 18, 2025

(54) CAPTURE AND STORAGE OF ATMOSPHERIC CARBON

(71) Applicant: Richard James Hunwick, Waterford (AU)

(72) Inventor: Richard James Hunwick, Waterford (AU)

(21) Appl. No.: 19/301,209

(22) Filed: Aug. 15, 2025

Related U.S. Application Data
(63) Continuation-in-part of application No. 17/772,609, filed on Apr. 28, 2022, now Pat. No. 12,409,413.

(30) Foreign Application Priority Data
Nov. 1, 2019 (AU) 2019904129

(51) Int. Cl. B01D 53/14; B01D 53/18; B01D 53/62; B01D 53/78; B01D 53/96; C01B 3/06; C01F 5/24

(52) U.S. Cl. CPC B01D 53/1425; B01D 53/1418; B01D 53/1475; B01D 53/1493; B01D 53/185; B01D 53/62; B01D 53/78; B01D 53/96; C01B 3/06; C01F 5/24; B01D 2252/102; B01D 2252/1035; B01D 2257/504; B01D 2258/06

(57) ABSTRACT

A process for producing hydrogen from a magnesium silicate that comprises ferrous iron is disclosed. The process includes mixing an aqueous solution that contains ammonium ions with the magnesium silicate that contains ferrous iron to form an ammoniated slurry. The process also includes subjecting the ammoniated slurry to reaction conditions by which the ferrous iron is caused to be released from the magnesium silicate and such that released ferrous iron reduces water, thereby forming hydrogen gas and ferric iron.

### RELATED APPLICATIONS

This application is a continuation-in-part application of U.S. application Ser. No. 17/772,609, filed Apr. 28, 2022, which is a U.S. National Phase Application of International Application No. PCT/AU2020/051192, filed Nov. 2, 2020, which claims priority to Australian Application No. 2019904129, filed Nov. 1, 2019, each of which are hereby incorporated by reference in their entirety.

### TECHNICAL FIELD

A method and system are disclosed for capturing carbon dioxide from the atmosphere. At the same time, the method and system can be used to generate electrical energy (e.g. electricity). Also disclosed is a process for producing hydrogen from a magnesium silicate that comprises ferrous iron.

### BACKGROUND ART

Internationally, there are imperatives to reduce carbon dioxide emissions to the atmosphere, as well as to reduce current levels of carbon dioxide in the atmosphere, with both efforts directed to help minimise the effects of global warming. To meet such goals, efforts to minimize carbon dioxide emissions at their sources must be joined by efforts to remove the gas from the broader atmosphere and store it permanently.

Carbon dioxide sinks exist naturally, including the weathering of silicate rocks to form carbonates, and the world's oceans. Plants are also an effective form of carbon dioxide sink and use photosynthesis to remove carbon from the atmosphere by incorporating it into biomass. However, these naturally occurring sinks are not capable of effectively keeping up with the vast quantities of carbon dioxide currently being released from anthropogenic sources.

The task implied is immense, therefore there must be a collective response if significant offsetting impacts are to be made. The costs will run into the hundreds of billions of dollars, raising the question of where the funds required will come from. Clearly, if the responses can strip carbon dioxide from the atmosphere while generating net revenues adequate to cover the necessary investment, the challenge becomes of a different, less daunting order.

Since carbon dioxide is present in the atmosphere at concentrations of only around 400 parts per million, systems that seek to remove carbon dioxide from the broader atmosphere must be capable of handling immense quantities of air. Such handling systems must also be capable of capturing the carbon dioxide from the vast air quantities passing through such systems and then storing it permanently.

US 2011/0171105 discloses a plant for capturing carbon dioxide from the atmosphere. To absorb carbon dioxide present in atmospheric air, the plant uses a calcium sulphate solution mixed with ammonia that is sparged into the atmospheric air that passes into the top region of an enclosure. Ammonium sulphate solution is captured in a reservoir located at a base of the enclosure. The scale and teaching of US 2011/0171105 is such that there is and could be no generation of energy, such as electrical energy.

US 2009/0081096 discloses a CO₂ scrubber in the form of a stainless steel reaction-chamber cylinder. A froth of calcium hydroxide solution and atmospheric air is generated by a froth generator located at a top of the reaction-chamber cylinder. This froth is caused to pass down through the reaction-chamber cylinder to a dewatering chamber, where a calcium carbonate solution is separated from the air. The air scrubbed of CO₂ is vented to atmosphere via an exhaust stack. Again, the scale and teaching of US 2009/0081096 is such that there is and could be no generation of energy, such as electrical energy.

The above references to the background art do not constitute an admission that such art forms a part of the common and/or general knowledge of a person of ordinary skill in the art. The above references are also not intended to limit the application of the method and system as disclosed herein.

### SUMMARY OF THE DISCLOSURE

Disclosed herein in a first aspect is a process for producing hydrogen from a magnesium silicate that comprises ferrous iron. The process can, at the same time, be used to remove carbon dioxide from a gaseous stream.

The process can comprise mixing an aqueous solution that comprises ammonium ions with the magnesium silicate that comprises ferrous iron to form an ammoniated slurry.

The process can also comprise subjecting the ammoniated slurry to reaction conditions by which the ferrous iron is caused to be released from the magnesium silicate and such that released ferrous iron reduces water, thereby forming hydrogen gas and ferric iron.

The process of the first aspect may be seen as both emulating and expediting the production of so-called ‘white hydrogen’. White hydrogen refers to naturally occurring hydrogen that is found in the Earth's crust or mantle. In this regard, white hydrogen is geologically sourced. It exists in nature and can potentially be extracted directly. Because such hydrogen is naturally occurring, its production does not inherently produce carbon dioxide, making it a potentially carbon-free energy source. However, there are still challenges associated with locating, quantifying and economically extracting white hydrogen. The use of white hydrogen on commercial scales is still a long time away. One mechanism by which white hydrogen is thought to be formed in nature is by the reduction of water by the ferrous iron. For instance, ultramafic rocks often comprise ferrous iron, which can substitute for magnesium within the crystal structure of the ultramafic rocks. In some cases, the iron can substitute as much as 10% of the magnesium within the crystal. Without being bound by theory, it is postulated that it is possible to emulate the natural formation of white hydrogen in a process whereby hydrogen is produced from an ultramafic rock, such as a magnesium silicate, that comprises ferrous iron.

As described herein, it has been discovered that, when the magnesium silicate that comprises ferrous iron is mixed with an aqueous solution that comprises ammonium ions, magnesium and ferrous iron present in the magnesium silicate will show a tendency to be hydrolysed. Typically, the rate of these reactions is slow. However, it has been found that the presence of ammonium ions in a solution will tend to enhance the rate at which magnesium hydrolyses. This is because the ammonium ion tends to react with hydroxyl ions formed as a result of the dissolution of magnesium. In turn, this allows the dissolution of further magnesium ions. Without being bound by theory, it is thought that this can in turn increase the rate of formation of cracks and fissures within the magnesium silicate and the rate at which the magnesium silicate fragments. Furthermore, it is thought that the hydrolysis rate of ferrous iron can be enhanced by the slightly alkali conditions that exist in a solution that comprises ammonium ions. In turn, the released ferrous iron reduces water, thereby forming hydrogen and ferric iron. Accordingly, without being bound by theory, it is postulated that the process of the first aspect can enhance the dissolution of ferrous iron to an extent whereby substantial quantities of hydrogen can be produced. Advantageously, because the hydrogen is not manufactured using prior art processes, its production does not inherently produce carbon dioxide.

In some embodiments of the process of the first aspect, the aqueous solution may comprise seawater or other brine.

In some embodiments of the process of the first aspect, the aqueous solution may comprise ammonium bicarbonate. In this regard, the reaction conditions may further comprise conditions by which the ammonium bicarbonate reacts with the magnesium silicate to form a magnesium carbonate and silica slurry. Ammonia may also be released and, in some embodiments, may be collected and reused to form the aqueous solution comprising ammonium bicarbonate.

In some embodiments of the process of the first aspect in which the aqueous solution comprises ammonium bicarbonate, the process may further comprise overlaying the ammoniated slurry with the aqueous layer to create a top aqueous layer and a bottom ammoniated slurry layer. The ammonia that is released from the bottom ammoniated slurry layer may be able to pass into the top aqueous layer. An aqueous solution comprising ammonia may thereby be produced. The aqueous solution may be reused to form the solution comprising ammonium bicarbonate. Furthermore, in some of these embodiments, the hydrogen gas may be able to pass through the top aqueous layer to be collected in a gas space located above the top aqueous layer. In this regard, it is thought that the conditions of the top aqueous layer can be controlled so as to promote the dissolution of the ammonia therein, such that the gas space is comprised primarily of hydrogen. In some of these embodiments, the aqueous layer that overlays the ammoniated slurry may comprise seawater or other brine.

In some embodiments of the process of the first aspect, the reaction conditions may comprise elevated temperatures and/or elevated pressures. For example, the elevated temperature may be below the boiling point of water at the elevated pressure. In some embodiments, an elevated pressure of the ammoniated slurry may be generated by overlaying the ammoniated slurry with the top aqueous layer. In one variation, the ammoniated slurry may be subjected to an elevated temperature of about 150° C. and an elevated pressure ranging from about 4.0 to about 5.0 Bar gauge. At the temperature of about 5.0 Bar gauge, the boiling point of the ammoniated slurry is elevated such that the ammoniated slurry does not boil at the temperature of about 150° C.

In some embodiments of the process of the first aspect, the magnesium silicate that comprises ferrous iron may comprise one or more of: olivine, enstatite, serpentinite, peridotite, dunite, harzburgite, lherzolite, wehrlite, forsterite, fayalite.

In some embodiments of the process of the first aspect, the aqueous solution comprising ammonium bicarbonate may be produced by scrubbing a gas stream with an aqueous solution comprising ammonia to remove carbon dioxide from the gas stream. In such embodiments, the hydrogen can be advantageously produced as a by-product of a process as disclosed herein in which carbon dioxide is sequestered using the magnesium silicate.

In some embodiments, the aqueous solution comprising ammonium bicarbonate may be produced in a process which comprises enabling atmospheric air to pass into an upper end of an elongate hollow tower. The elongate hollow tower may have a lower end and a height measured from the upper end to the lower end. The process may also comprise charging the aqueous solution comprising ammonia so as to mix with atmospheric air within and adjacent to the elongate hollow tower upper end in a manner such that the air is cooled by evaporative cooling. The mixture may pass (or be caused to pass) downwards as a stream through the elongate hollow tower. As the mixture passes downwards as a stream through the elongate hollow tower, the aqueous solution comprising ammonia reacts with the carbon dioxide to form the aqueous solution comprising ammonium bicarbonate.

In certain embodiments, the process may further comprise generating electricity from the downwards stream that is passing through the elongate hollow tower. For example, the electricity may be generated from the downwards stream by passing it through one or more gas turbines that are configured to generate electricity. The electricity generated may be in excess of that required to power the overall process, including the process of the first aspect.

The process may further comprise separating the aqueous solution comprising ammonium bicarbonate from the downwards stream. In accordance with the process of the first aspect, said separated solution may be reacted with the metal silicate to form a magnesium carbonate and silica slurry. At the same time, hydrogen may be produced from ferrous iron present in the metal silicate. In addition, ammonia may be released back into the solution for recovery and reuse in the elongate hollow tower.

The reaction of the ammonium bicarbonate with the metal silicate may also result in the production of carbon dioxide. Such carbon dioxide produced as a result of reacting the ammonium bicarbonate with the metal silicate may be collected and reacted with the aqueous solution that comprises ammonia to form more ammonium bicarbonate, able to react with additional metal silicate. In this way, it can be possible to prevent the release of the carbon dioxide back into the atmosphere.

In some embodiments, the metal carbonate and other insoluble solids may be separated from the aqueous solution. The aqueous solution may be recycled to recover ammonia for re-use in the elongate hollow tower. In this regard, prior to said separation, the process may further comprise heating of an aqueous slurry that comprises the metal carbonate and other insoluble solids. The heating may be conducted to distil off the ammonia present in the solution. The distilled off ammonia along with distilled off water may be collected and condensed to form an ammonia-in-water solution. Said solution may be recycled to the elongate hollow tower.

In some embodiments in which the aqueous solution comprising ammonium bicarbonate is produced in a process which comprises enabling atmospheric air to pass into an upper end of an elongate hollow tower, the upper end of the elongate hollow tower may be open. The aqueous solution may be charged as droplets or mist into the air within and adjacent to the elongate hollow tower open upper end. As the mixture passes downwards as a stream through the elongate hollow tower, more atmospheric air may be caused to pass into the elongate hollow tower open upper end to mix with aqueous solution being charged into and adjacent to the elongate hollow tower upper end.

Also disclosed herein is a method and system for sequestration of carbon dioxide from atmospheric air. The method and system can, at the same time, be configured to generate electrical energy—e.g. electricity. The electricity generated may be in excess of that required to power the overall method, system and process as disclosed herein.

In accordance with the method and system as disclosed herein, atmospheric air is enabled to pass into an upper end of an elongate hollow tower. An aqueous solution can be charged within and adjacent to the tower upper end. The aqueous solution can comprise a reagent added thereto that reacts with the carbon dioxide to form a compound in the solution to thereby sequester the carbon dioxide from the atmospheric air. The aqueous solution comprising the reagent can be charged so as to mix with the atmospheric air in a manner such that the air is cooled by evaporative cooling. As a result of such evaporative cooling, the mixture can pass downwards as a stream through the hollow tower. Electricity can be generated from the downwards stream that is passing through the hollow tower. In this regard, the hollow tower can be sized and located such that the downwards stream can possess significant kinetic energy (e.g. sufficient to power gas turbines).

The method and system have been developed to handle vast quantities of air, and to capture the carbon dioxide present in such vast air quantities, with the option of then storing the captured carbon permanently. Because the method and system as disclosed herein seek to capture as much of the carbon dioxide present in atmospheric air as possible, vast quantities of air are required to be processed (i.e. due to the relatively low concentrations of carbon dioxide in atmospheric air). As such, the method and system ultimately envisage multiple facilities deployed on a large scale.

In the method and system as disclosed herein, typically the hollow tower is a very tall tower (i.e. as set forth below). The reagent (e.g. in aqueous solution) is mixed with the atmospheric air passing through the hollow tower and is typically charged adjacent to an open upper end of the tower. Typically, a reagent is selected that is reactive with the carbon dioxide in the air to produce a compound that comprises the carbon dioxide, thereby sequestering or ‘scrubbing’ the carbon dioxide from the air. As necessary, this compound may be further reacted into a form that enables the carbon dioxide to be stored permanently. At the same time, electricity can be generated from the downwards stream. For example, electricity can be generated from ‘CO₂-scrubbed air’ that passed through and from the tower. This CO₂-scrubbed air can contain so much kinetic energy that it may provide sufficient (and potentially excess) energy for the overall capture and permanent storage of such ‘atmospheric carbon’. For example, the CO₂-scrubbed air may provide sufficient (and potentially excess) energy compared to the energy required for securing and processing, as required, raw materials and the recycling and benign disposal of any wastes.

Whilst a particularly suitable reagent can be ammonia (e.g. that may be produced in a facility located adjacent to the tower), other reagents can include: ammonium (e.g. an ammonium salt in aqueous solution); an oxide/hydroxide pairing e.g. in aqueous solution (such as an oxide/hydroxide pairing based on magnesium and/or calcium and/or lithium, etc.); amines such as the alkylamines and alkanolamines DEA, ETA/MEA, and MDEA; inorganic solvents such as alkaline solvents; etc.

Ammonia is a particularly suitable reagent as it can be readily produced and supplied on site to the tower such as in an aqueous solution (i.e. as an ammonia-in-water solution). There is an inherent simplicity and reliability in using an ammonia-in-water solution to remove carbon dioxide from atmospheric air. Additionally, when in solution, ammonia can readily react with (and thus capture) the relatively low levels of carbon dioxide present in the immense quantities of air that aim to be processed in the method and system as disclosed herein. The resultant ammonium bicarbonate that is produced from the reaction of ammonia with carbon dioxide can also be readily further treated, as set forth below, into a form whereby the carbon dioxide is effectively stored permanently. The use of ammonia as the reagent is described in more detail hereafter.

As above, another suitable reagent is magnesium hydroxide. Magnesium hydroxide in solution is readily able to react with and thereby ‘scrub’ the carbon dioxide from the atmospheric air passing through the tower. Magnesium hydroxide has the added benefit that the final compound produced (i.e. magnesium carbonate) is an already stable, captured/sequestered form of CO₂, which can be safely disposed of.

A magnesium hydroxide solution can readily be formed by adding abundant magnesium oxide (e.g. from suitably treated minerals such as magnesite, dolomite, brucite, serpentinite, etc.) to water according to the following reaction:

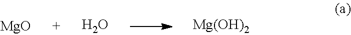

The resultant magnesium hydroxide solution can then be employed in the tower to react with CO₂ present in the atmospheric airstream entering the tower upper end, according to one or more of the following reactions:

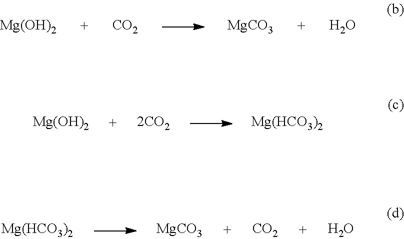

Likewise, in place of, or in addition to magnesium, calcium and/or another alkaline-earth metal; and/or lithium or another alkali metal (sodium, potassium, etc.), can be used as the oxide/hydroxide pairing in aqueous solution. However, it is observed that magnesium hydroxide is particularly suitable. WO 2017/106293 describes this in further detail and the reactions and suitable conditions for the use of magnesium hydroxide, etc. to scrub CO₂ from a gas stream. The relevant contents of WO 2017/106293 are incorporated herein by way of cross-reference.

In some embodiments, the method for sequestration of carbon dioxide from atmospheric air may comprise enabling the atmospheric air to pass into an upper end of the elongate hollow tower (typically via an open upper end of the tower). The elongate hollow tower may be a purpose-built tower, such as a so-called ‘energy tower’. An advantage of using an energy tower is that it can be configured to generate electricity from the flow of atmospheric air passing down through the hollow tower. For example, in an energy tower, the kinetic energy of the downstream flow of atmospheric air through the hollow tower can be captured or harnessed (e.g. converted into electrical energy).

In some embodiments, the tower can comprise electricity generation apparatus such as one or more gas (e.g. air) turbines. Other embodiments may additionally or alternatively comprise wind turbines (e.g. vertical and/or horizontal axis wind turbines). Typically, such turbines are located at a tower lower end (e.g. tower base) and can be activated (and thereby run continuously) as the airstream exits the tower lower end. Employing an electricity generation apparatus can enable the method and system to capture atmospheric carbon and generate electricity at the same time. It should be understood that the electricity generation apparatus may be installed elsewhere within or in the vicinity of the tower, where it is able to intercept or otherwise interact with the airstream.

As set forth above, the downstream flow and the electricity generation apparatus may be sufficient such that the amount of electricity generated can exceed that required to power the overall method, system and process as disclosed herein. In other words, the method and system may be a net producer/exporter of electrical energy. Thus, the method and system of CO₂ sequestration can ‘pay for itself’.

As set forth above, in some embodiments the tower can comprise a so-called ‘energy tower’. Examples of an energy tower are shown in each of U.S. Pat. Nos. 3,894,393, 6,510,687 and 6,647,717. It is noted that such towers are best located in coastal, hot-desert environments, i.e. to make use of the hot, dry (i.e. low humidity) atmospheric air and abundant supply of seawater.

Typically, the tower is constructed to be tall enough such that its upper end projects up to, at, or more typically above the subtropical inversion layer/level, which is typically around one kilometre above sea level (and which also varies daily and seasonally), especially in hot desert environments. For example, the tower may be constructed with a height such that it mostly projects well above this inversion layer, and into air that is extremely dry and of low humidity for most of the year (i.e. in such hot-desert environments). In an embodiment, the tower may be ˜1.2 kilometres high (i.e. such a tower would be half as tall again as currently the world's tallest building, the Burj Khalifa in Dubai). In an embodiment, the tower may have a clear internal diameter at its narrowest point (e.g. at an open upper end thereof) of ˜0.4 kilometres. When the tower is this height (>˜1 kilometre), typically the aqueous solution comprising the reagent will need to be pumped up to the upper end of the energy tower using a number of pumps, each with a high capacity.

In some embodiments of the method, an aqueous solution (e.g. comprising the reagent) may be charged into the tower, so as to mix with atmospheric air located within and adjacent to the tower upper end. The aqueous solution may be charged into the tower upper end in a manner such that the air is cooled by the aqueous solution—i.e. by evaporative cooling. For example, the aqueous solution may be sprayed across the top of the tower (e.g. downwards into and/or transverse to the air located within and adjacent to the tower upper end). When the tower is located in an environment (e.g. a desert) in which the atmospheric air is hot and dry, at least some of the aqueous solution that is charged into the tower will evaporate, thereby cooling and humidifying the hot, dry (e.g. ambient desert) air. This makes the air within the upper end of the tower denser, leading to a powerful, ‘reverse-chimney’ effect. The mixture of aqueous solution and air (i.e. humidified air) thereby passes downwards as a stream through the hollow tower. When the aqueous solution comprises a reagent added thereto that can react with the carbon dioxide, the reaction of the reagent with the carbon dioxide can take place as the combined stream passes downwards through the tower, thereby progressively forming more of the compound in the solution. The combined stream is referred to herein as the “downwards stream” and is also referred to herein as the “airstream” or the “downstream”.

In some embodiments of the method, the aqueous solution may have the reagent already added thereto prior to its charging into the tower. Alternatively or additionally, the aqueous solution may be mixed with a separate (e.g. aqueous) solution that comprises the reagent, with such mixing of solutions taking place either prior to charging the aqueous solution into the tower or within the tower itself (e.g. as part of the charging step).

In some embodiments of the method, the aqueous solution can comprise seawater or other brine. The other brine may e.g. be brackish water, or it may be a manufactured brine (e.g. using a locally available salt source). It is noted that seawater or brine may favour some of the reactions as disclosed herein. When the aqueous solution comprises seawater, and depending on the location of the tower, such a source can represent an inexhaustible source of the large volumes of water expected to be required for large-scale deployment of the method and system as disclosed herein.

The high downdraft velocities across a tower that is constructed with a large cross-sectional area can represent an immense airflow. When this airflow passes through and/or is directed through suitable electricity generation apparatus, such as one or more (e.g. batteries) of suitably selected and configured air turbines, substantial quantities of electricity may be generated. As above, any excess electrical energy generated can be available for export (i.e. after allowing for the demands of the method and system itself, which include: pumping (sea) water to the top of the tower and other system pumping requirements; reagent production and mixing; materials separation and handling stages; etc.).

In some embodiments of the method, the solution comprising the compound may be separated from the downwards stream, with a ‘scrubbed’ airstream able to be released back to atmosphere. For example, the method can be operated to produce a cooler, humidified, CO₂-scrubbed airstream that is enabled to exit the tower. The CO₂-scrubbed airstream may exit via the one or more suitable turbines. As set forth above, these may be located at the tower lower end (e.g. base) and are typically configured to generate electricity.

As set forth above, typically the atmospheric air is enabled (e.g. caused) to pass into an open upper end of the hollow tower. For example, the method can be operated continuously whereby, as the atmospheric air passes into the tower via its open upper end and is cooled (e.g. by mixing with the aqueous solution being continuously charged into and adjacent to the tower upper end), the humidified air/solution mixture immediately starts to descend in the tower, whereby more atmospheric air is drawn into the tower open upper end, is cooled, descends, and so on. Electricity generation can, as a result, also be continuous.

In some embodiments of the method, the aqueous solution may be charged (e.g. sprayed, atomised, misted, etc.) as droplets or mist into the air within and adjacent to the tower upper end. This promotes both rapid evaporative cooling, as well as rapid mixing of the air with the aqueous solution, whereby reaction of the CO₂ with the reagent commences immediately.

In some embodiments of the method, the solution comprising the compound may be separated from the downwards stream and collected at a lower end of the tower. As set forth below, the solution comprising the compound can be ‘regenerated’ from the humidified airstream, such as by eliminating the solution (e.g. using mist eliminators) and/or by condensation of the solution (e.g. on relatively cooler surfaces). The solution may then be collected (and optionally stored) for subsequent processing.

When the reagent added to the aqueous solution comprises ammonia, the compound formed in the solution can comprise ammonium bicarbonate. The solution comprising ammonium bicarbonate may be separated from the scrubbed airstream and may be reacted with a metal silicate to form a metal carbonate or bicarbonate and silica. Advantageously, this can also release ammonia back into the solution. Thus, ammonia can be regenerated, so can be seen to act as a catalyst in the method, system and process as disclosed herein. The reaction of the ammonium bicarbonate solution with the metal silicate can also produce an aqueous slurry.

In other embodiments of the method, the reagent added to the aqueous solution may comprise magnesium hydroxide (e.g. produced from magnesium oxide added to the solution) and the compound formed in the solution can comprise magnesium carbonate. Thus, the solution that is separated from the scrubbed airstream comprises magnesium carbonate and this may readily be separated from the solution and safely disposed of (e.g. repatriated back to a mined site or passed with e.g. seawater to the ocean, etc.).

It should be noted that metal silicate minerals are abundant in the Earth's crust and thus the method can make use of a mineral that is likely to be found in close proximity to the tower(s). For example, abundant ultramafic (also known as ultrabasic) rocks are those rich in the magnesium-rich silicate minerals olivine Mg₂SiO₄, enstatite MgSiO₃, and serpentinite Mg₃Si₂O₅(OH)₄. Further, the olivine-rich rock-peridotite is the major component of the Earth's mantle, making it the Earth's most abundant rock. Peridotite tends to embrace a range of minerals that have their own range of compositions between olivine and enstatite including dunite, harzburgite, lherzolite and wehrlite. Other suitable sources of metal silicate minerals include the nickel- and other base metal-rich ultramafic rock komatiite, found in ancient cratons in Australia, Canada and South Africa. Such rocks may be exposed and thus accessible in desert environments. Such minerals may be used in either the ammonium bicarbonate reaction and/or the formation of magnesium hydroxide solution.

When ultramafic rocks are exposed to wind and rain over geological time periods, these rocks are converted (i.e. weathered) to carbonate rocks (e.g. magnesite-MgCO₃) plus silica. In this regard, the mineral olivine is more reactive than the mineral serpentinite, hence is generally less common within the upper, more exposed levels of the Earth's crust. Hence, in some embodiments, the method and system may seek to emulate nature, by making use of less-weathered forms of the metal silicate minerals (e.g. MgO) to react with the compound (e.g. ammonium bicarbonate) that is formed in the solution recovered from the energy tower and/or to form magnesium hydroxide solution. Other ways by which the reactions may be accelerated include crushing and finely grinding the ultramafic rocks (i.e., prior to being reacted with the compound (e.g. ammonium bicarbonate) in solution. In an embodiment, the ultramafic rocks may be crushed and finely ground to a particle size distribution of 80% passing a 100 micron aperture sieve. In another embodiment, the ultramafic rocks may be crushed and finely ground to a particle size distribution of 80% passing a 50 micron aperture screen.

In some embodiments of the method, when a metal bicarbonate is formed by reacting the metal silicate with ammonium bicarbonate in the solution (i.e. the solution that is recovered from the airstream), this metal bicarbonate may be further converted into a metal carbonate. The resulting metal carbonate represents a ‘sequestered’ form of the atmospheric carbon dioxide, with the metal carbonate able to be ‘stored’ (e.g. returned back to the original site from which the metal silicate mineral was sourced/mined). When the metal silicate mineral is a magnesium-rich silicate mineral (such as olivine Mg₂SiO₄, enstatite MgSiO₃, or serpentinite Mg₃Si₂O₅(OH)₄), the carbonate that is produced and that can be stored can typically comprise magnesite (MgCO₃). Magnesite is a geologically stable mineral that may be viewed as ‘stored carbon dioxide’.

In the course of converting e.g. bicarbonate to carbonate, carbon dioxide is produced. This CO₂ can be reacted with additional reagent to thereby produce more compound for reacting with the metal silicate. However, as set forth above, such a reagent (e.g. ammonia) can be regenerated for re-use in the energy tower to scrub more atmospheric CO₂. However, because of the abundance of magnesium in various mineral types, MgO and magnesium hydroxide typically do not need to be regenerated.

In some embodiments of the method, the carbon dioxide produced during conversion of the bicarbonate to carbonate may be collected and ‘recycled’/reacted with the ammonia in aqueous solution (i.e. in the aqueous slurry) to form more ammonium bicarbonate, which additional ammonium bicarbonate is then able to react with additional metal silicate.

Again, and as explained in further detail below, it should be noted that the overall result is a net removal and conversion of the atmospheric carbon dioxide to a suitable ‘storable’ metal carbonate form.

In some embodiments of the method, the metal carbonate that is ultimately produced may form a precipitate and thus may readily be separated from the aqueous solution (i.e. from the aqueous slurry). The precipitate, along with other insoluble solids present in the metal silicate mineral, may be separated from the aqueous solution (i.e. slurry) using e.g. known solids-liquids separation techniques/apparatus.

Typically, prior to the solids-liquids separation, the reagent (e.g. ammonia) may be recovered from the aqueous slurry for recycling to the tower (i.e. for re-use in scrubbing of atmospheric CO₂ in the tower).

For example, in one embodiment, prior to passing the slurry to the solids-liquids separation stage, the method may further comprise heating of the aqueous slurry comprising the metal carbonate and other insoluble solids.

The heating may be conducted to distil off e.g. the ammonia present in the slurry/solution. As set forth below, the heating may be performed in a multi-stage distillation apparatus. The distilled off ammonia, along with distilled off water, may be collected and condensed to (re)form an ammonia-in-water solution (e.g. in a more suitably concentrated form). This (optionally concentrated) solution may then be recycled to the tower for further use in scrubbing of atmospheric CO₂ in the tower.

In some embodiments, the collected ammonia-in-water solution may be concentrated in an additional ammonia-water separation stage, such as a fractionating facility that partially fractionates the solution (e.g. by distillation processes) to produce a stream of potable water and a second stream that contains essentially all of the ammonia but in a more concentrated aqueous solution. This more concentrated aqueous solution may comprise the solution that is recycled to the tower for further use in scrubbing of atmospheric CO₂ in the tower.

When the method and system as disclosed herein are deployed in adjacency of concentrated sources of carbon dioxide (e.g. thermal power stations, raw natural gas processing plants, ammonia plants (fuelled by natural gas), cement plants and the like), it is conceivable that at least a proportion of the flue and other gas emissions may be directed to the elongate tower for processing in accordance with the present method and system, rather than being released directly to atmosphere.

Also disclosed herein is a system for sequestration of carbon dioxide from atmospheric air. As set forth above, the system can comprise an elongate hollow tower that is configured such that the atmospheric air containing carbon dioxide is able to pass downwards through the tower from a tower upper end towards a tower lower end. For example, the tower can be constructed such that its upper end is open. In an embodiment, the tower may be constructed to flare out towards the tower upper end to provide a wide ‘throat’ that enhances the passage therein of the atmospheric air. As set forth above, the tower may be located and sized so as to produce a downwards stream with significant kinetic energy.

The system can further comprise a distributor that is arranged to charge (e.g. to spray, atomise, mist, etc.) into the tower an aqueous solution comprising a reagent therein that is able to react with the carbon dioxide to form a compound in the solution. The formation of the compound in the solution sequesters the carbon dioxide from the atmospheric air. When charged into the tower, the aqueous solution mixes with the atmospheric air to evaporatively cool the air, thereby causing the mixture to pass as a downwards stream through the tower. As set forth above, as the stream passes downwards through the tower, the carbon dioxide is able to react with the reagent to form the compound in the solution. As set forth above, the aqueous solution may comprise ammonia as the reagent (forming an ammonia-in-water solution) or it may comprise magnesium hydroxide as the reagent in solution. Typically, the aqueous solution comprising the reagent is pumped up to the distributor. The compound (e.g. ammonium bicarbonate or magnesium carbonate, respectively) can progressively be formed in the aqueous solution as its passes downwards through the tower.

The system can further comprise electricity generation apparatus. The electricity generation apparatus can be arranged to generate electricity from the downwards stream that is passing through the hollow tower. As set forth above for the method, the electricity generation apparatus may comprise one or more gas (e.g. air) turbines configured to generate electricity. The one or more gas turbines may be arranged at the tower lower end (e.g. tower base). Each gas turbine may comprise a specially configured air turbine that is arranged to receive therethrough the airstream scrubbed of carbon dioxide, to thereby generate electricity, prior to the scrubbed airstream exiting the tower to atmosphere.

However, other types of electricity generation apparatus may be employed in conjunction with the tower, to harness the kinetic energy of the downwards stream, e.g. such as wind turbines (e.g. horizontal axis windmills located within the tower, vertical axis wind turbines arranged at a downstream outlet from the tower, etc.). Another example is a system whereby the droplets of brine are caused to be electrically charged, enabling electricity to be generated efficiently by the technique of charge separation, without recourse to moving parts.

In some embodiments, the system may additionally comprise a separator. The separator may be arranged to separate the solution comprising the compound from the downwards (air) stream. Thus, an airstream that is scrubbed of carbon dioxide is enabled to exit the tower. The separator may be arranged at a lower end of the tower to facilitate release of a scrubbed (and humidified) airstream from the tower at its lower end. As set forth above, the separator may comprise a surface and/or mist eliminators that are arranged at e.g. a base located at the tower lower end such that the solution comprising the compound is able condense and/or coalesce at and thus be separated by the separator.

In some embodiments, the electricity generation apparatus may be arranged to generate electricity from the scrubbed airstream produced by the separator. The electricity generation apparatus can be further arranged to release the scrubbed airstream from the tower. For example, the surface may be located prior to the electricity generation apparatus (e.g. prior to the gas turbines). Further, the mist eliminators may be located prior to and/or after the electricity generation apparatus (e.g. after the gas turbines). The surface may comprise a convex or parabolic surface located at the base of the tower, which can thereby direct the descending air downstream to the electricity generation apparatus (e.g. to the gas turbines).

In some embodiments, the distributor may be arranged to distribute (e.g. spray, etc.) the aqueous solution comprising the reagent as droplets or mist into air located adjacent to an open upper end of the tower. The resultant mixture of evaporatively cooled air and moisture that passes downwards as a stream through the hollow tower has the effect of drawing more atmospheric air into the open upper end of the hollow tower to mix with further aqueous solution that continues to be charged into and adjacent to the tower upper end, and so on to produce a continuous downstream.

In some embodiments, the system may further comprise a collector. The collector may take the form of one or more holding vessels (e.g. holding launders). The holding vessels (e.g. launders) can be arranged to receive the solution that is separated by the separator. The holding vessels can allow for a build-up (i.e. a banking) of solution with atmospheric CO₂ captured therein. This then enables the solution to be systematically and continuously processed to ultimately produce a sequestered form of CO₂.

In some embodiments, the system may further comprise apparatus for producing the aqueous solution that comprises the reagent therein that is able to react with the carbon dioxide to form a compound in the solution.

When, for example, the reagent is ammonia, the apparatus for producing the aqueous solution may comprise a plant for recovering ammonia from the aqueous solution (e.g. from slurries) produced during operation. Optionally, the system may also comprise a plant for the production of additional ammonia as may be required to make up for any losses in the overall method and system. The ammonia may be added to the aqueous solution (e.g. to seawater) to produce an ammonia-in-water solution for use in the system.

When, for example, the reagent is magnesium hydroxide, the apparatus for producing the aqueous solution may make use of the reactors as described hereafter for treating and processing a metal silicate (e.g. these reactors can be used to produce MgO which, when added to solution, produces magnesium hydroxide reagent). When the reagent is ammonia, the system may further comprise one or more reactors. Each reactor may comprise a series of reactors. The reactors may be arranged to receive the solution comprising ammonium bicarbonate that is separated by the separator and subsequently flows into the collector. The reactors may be further arranged such that the ammonium bicarbonate solution is able to be mixed with a metal silicate, such as one or more of the suitably treated (e.g. crushed and ground/milled) metal silicate minerals as set forth above, to form a slurry. Prior to passing into and/or whilst in the reactors, the solution/slurry may become heated to promote the formation of metal bicarbonate, metal carbonate and silica, and further to convert the metal bicarbonate into metal carbonate, while releasing ammonia back into solution, to form more ammonium bicarbonate. The heat can come from heat exchange prior to the solution passing into the reactor(s) and can also come from the reaction itself (i.e. the reaction being exothermic).

When the reagent is ammonia, the system may further comprise one or more separation units. The separation units can be arranged to separate the metal carbonate (and other insoluble solids present in the metal silicate mineral) from the slurry.

When the reagent is ammonia, the system may further recover ammonia from the slurry for re-use in the tower. In this regard, the one or more separation units may comprise distillation apparatus (e.g. a multi-stage distillation facility such as a multi-stage flash evaporator) that is arranged for heating the slurry that comprises the metal carbonate (along with other insoluble solids). The distillation apparatus can distil off ammonia present in the slurry.

When the reagent is ammonia, the system may comprise a condenser in which the ammonia along with water distilled off in the distillation apparatus are condensed to form an ammonia-in-water solution. The ammonia-in-water solution may be recycled for re-use in the energy tower.

When the reagent is ammonia, the system may further comprise an ammonia-water separation facility, such as fractionating apparatus. An apparatus can be selected that partially fractionates the condensed solution (e.g. by distillation processes). This can produce a stream of potable water as well as a second stream that contains essentially all of the ammonia, but in a more concentrated aqueous solution to be recycled to the tower for further use in scrubbing of atmospheric CO₂ in the tower.

Additionally, the one or more reactors and separation units may be further arranged such that the carbon dioxide produced from the conversion of the metal bicarbonate into metal carbonate can be collected and recycled/reacted with the ammonia in solution to form more ammonium bicarbonate. This additional ammonium bicarbonate may be reacted with additional metal silicate to produce more metal carbonate and more ammonia in solution.

When the reagent is magnesium hydroxide, the resultant magnesium carbonate (i.e. that is produced in the solution passing downwards through the tower) can easily be separated and then safely disposed of (e.g. passed to the ocean with seawater, repatriated to a mine site, etc.). Due to the abundance of magnesium reagent feedstock in various mineral types, it is not necessary to reprocess the resultant magnesium carbonate to produce more magnesium hydroxide reagent.

When the solution passing downwards through the tower comprises a proportion of magnesium bicarbonate, the resultant separated solution can be aged (e.g. in thickening reactors) to enable more of the magnesium carbonate to form, prior to disposal. However, if disposing to the sea, magnesium bicarbonate can pass with the slurry to the sea (i.e. magnesium bicarbonate is abundant in the sea). Also, magnesium carbonate, un-reacted magnesium hydroxide and magnesium bicarbonate, being alkaline, all function to offset increased ocean acidity.

### BRIEF DESCRIPTION OF THE DRAWINGS

Embodiments of a process, method and system as set forth in the Summary will now be described, by way of example only, with reference to the accompanying drawings, in which:

FIG. 1 is a schematic flow diagram of a first embodiment of a carbon dioxide sequestration method and system set forth in the Summary.

FIG. 2 is a schematic flow diagram of initial stages of the method and system as shown by the box in dotted outline in FIG. 1.

FIG. 3 is a schematic depiction of an energy tower for use in a method and system as set forth herein.

FIG. 4 is a further schematic partly cross-sectioned depiction of an energy tower that has been modified for use in a method and system as set forth herein.

FIG. 5 is a plan elevation of the modified energy tower as set forth in FIG. 4.

FIG. 6 is a schematic diagram of a reactor for converting carbon dioxide captured from the atmosphere, using an ammoniated brine, to mineral carbonates using ultramafic rocks, and for recovering ammonia.

### DETAILED DESCRIPTION OF SPECIFIC EMBODIMENTS

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

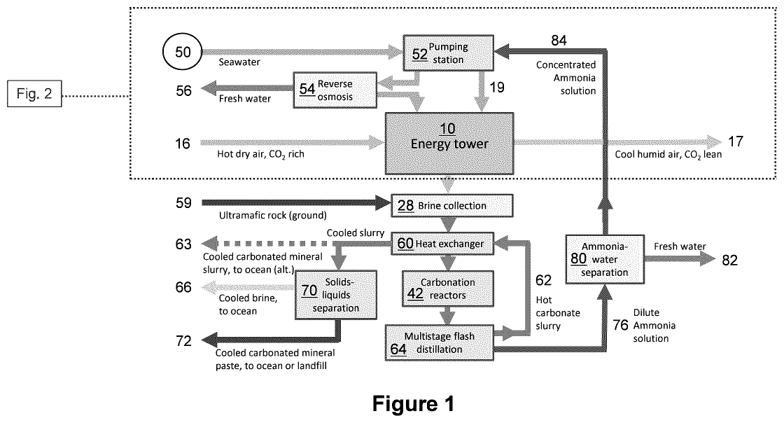

In the method and system as depicted in FIGS. 1 to 5, the reagent referred to and described is ammonia. However, where the reagent is e.g. magnesium hydroxide, a modified ‘downstream’ setup for the method and system would result, due to there being no need to recycle magnesium carbonate reagent by-product (i.e. this by-product is stable and safe for disposal). Further, a ready re-supply of magnesium for magnesium hydroxide reagent generation is available across most regions of the earth.

### Background Discussion

Prior to describing the method and system as depicted in FIGS. 1 to 5, some background on the application of the olivine-rich rock peridotite in the reaction with and storage of carbon dioxide will first be provided. Also, it should be understood that other ultramafic rocks may be applied to this end. Such reactions may be utilised as part of the present method and system to securely store (sequester) carbon dioxide.

When ultramafic rocks, such as olivine, are exposed to wind and rain over geological time periods, these rocks are converted (i.e. weathered) to carbonate rocks (e.g. magnesite—MgCO₃) plus silica. The reactions involved may be complex, but in environments which the process, method and system seek to emulate, there is a sequence of reactions by which olivine (in this example the magnesium end-member forsterite Mg₂SiO₄) in the presence of water and CO₂ can combine to form magnesium carbonate:

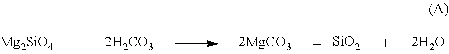

where the solution of water with CO₂ may be referred to as carbonic acid.

With serpentinite the reaction may be written as:

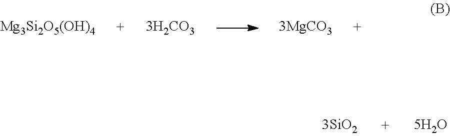

These reactions tend to be slow, unless carried out under high pressures to maintain a high partial pressure of carbon dioxide. Significantly, olivine reacts with carbon dioxide in aqueous solution more rapidly than does than serpentinite. Complicating matters arise when the olivine-rich minerals that are used derive from the reaction by which olivine is converted to serpentinite in water but in the absence of CO₂: a process referred to as serpentinization:

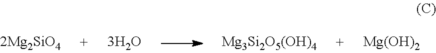

Also formed is the mineral brucite, magnesium hydroxide. This is generally insoluble in seawater, which tends to be slightly alkaline (pH 7.5-8), and its formation can tend to be substantially slow, the serpentization process.

Significantly, it has been discovered that brucite is relatively soluble in solutions comprising an ammonium salt. Such a salt may be ammonium bicarbonate, e.g., as may be formed as seawater comprising ammonia reacts with atmospheric CO₂ present in air passing down an energy tower, thereby forming a solution comprising ammonium bicarbonate. When the seawater exiting the energy tower, now containing ammonium bicarbonate, is mixed with the silicate, the following reactions can occur:

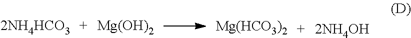

The magnesium bicarbonate has a low solubility in water, hence is a low solubility product and, after a small number of hydroxide ions enter solution, the reaction stops. However, and as explained below in more detail, when ammonium ions are present (e.g. under seawater pH conditions) these tend to combine with the hydroxyl ions present to form essentially un-ionized ammonium hydroxide. This, in turn, lowers the concentration of hydroxyl ions in solution. This encourages more magnesium hydroxide to dissociate, allowing more hydroxide ions to enter solution, which are in turn, removed by combining with more ammonium ions. The process continues until either all of the ammonium ions are removed to form essentially un-ionized ammonium hydroxide, or all of the magnesium hydroxide has dissolved.

It has also been observed that olivine and serpentinite in water will hydrolyse to some extent, releasing magnesium ions into solution at a rate dependent upon the solubility product of magnesium hydroxide, which will also be affected by the presence of ammonium salts in solution.

A second pathway for removal of magnesium ions from solution is for them to react with the bicarbonate ion to form magnesium bicarbonate as per the above reaction. In the presence of ample quantities of ultramafic rock minerals, the magnesium bicarbonate will be converted to the normal carbonate:

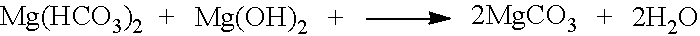

Conditions are selected for these reactions to occur (i.e. without the formation of hydrated forms of magnesium carbonate e.g. the mineral nesquehonite, or basic magnesium carbonates: combinations of carbonate and hydroxides). Such conditions include ample time, along with moderate pressures, such as 5 Barabs or more, and temperatures of the order of 150° C. or more. A particular embodiment of the process as disclosed herein, that allows the efficient heating and pressurization of the reactive slurry from the tower, and recovery of ammonia, is described in further detail below.

Regarding completion times for these reactions, in the absence of ammonia, periods measured in terms of several weeks can be required. However, as outlined below, it has been observed that the presence of ammonia can accelerate reaction times because the ammonia raises the concentrations in the reactive solutions of carbon dioxide, and of magnesium values by mechanisms as set out below. It follows that reaction times can be an order of magnitude faster: e.g. less than seven days. Ammonia's role therefore is a valuable catalytic one, with the ammonia able to be fully recycled.

Notably, ultramafic rocks such as olivine, including peridotite and serpentinite, are some of the original sources of valuable base and precious metals, such as chromium, nickel, cobalt and platinum-group metals. Considering just nickel and cobalt, background concentrations in a typical peridotite may average 0.25%, for nickel and 0.025% for cobalt, but higher concentrations are not uncommon, particularly with komatiites. Substantially larger tonnages of iron are present in typical olivines, where 10% or more of the magnesium atoms may be replaced by divalent iron (the magnesium end-member of olivine is forsterite, the iron end-member of olivine is fayalite).

The overall reaction by which carbon dioxide converts the mineral olivine to ‘stored carbon dioxide’ can be represented as:

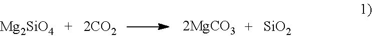

This reaction is strongly exothermic, which promises an overall methodology that is able to generate useful amounts of surplus heat energy. However, while the reaction is fast in geological terms it is slow in industrial terms. Its kinetics may be enhanced by the presence of common salts such as found in seawater: sodium chloride and bicarbonate, by the catalytic effects contributed by ammonia (including as ammonium salts) as described earlier and also below, and by agitating the particles to remove continuously any build-up of impermeable, hence reaction-limiting, silica scale on the growing magnesite crystals. At low temperatures, hydrated forms of magnesite such as the mineral nesquehonite MgCO₃·3H₂O tend to form, which represent sub-optimal carbon dioxide storage options compared with magnesite. Optimal reaction conditions as set forth herein are selected to favour the production of magnesite rather than such hydrated compounds, although in some embodiments, e.g. where discharge of a blend of hydrated forms of magnesite including nesquehonite, along with silica, directly into the ocean is acceptable (e.g. to counter effects of ocean acidification), no further processing prior to such discharge (other than to recover ammonia) may be required.

Known methods for speeding up the overall reaction 1) have tended to focus on raising the partial pressure of carbon dioxide by compressing it to pressures in excess of 100 Bar, and heating the reactants dispersed in water to around 185° C., this temperature being an optimum between accelerating the rate of reaction 1), and minimising the tendency of magnesite to decompose to magnesium oxide and carbon dioxide at higher temperatures (see e.g. “A review of mineral carbonation technologies to sequester CO₂.” A. Sanna, M. Uibu, G. Caramanna, R. Kuusk, and M. M. Maroto-Valer. Chem. Soc. Rev., 2014, 43, 8049).

At these temperatures and pressures, in the presence of water containing common salt and sodium bicarbonate, reaction 1) can essentially complete in around 6 hours. With temperatures in the hot brine occupying the lower level of the reactor-thickeners, the carbon dioxide in solution and, in particular, the presence of ammonia and ammonium salts (carbonate), the solubility of magnesium oxide and hydroxide, and by extension silicates, is enhanced. The reason for this derives from the weak dissociation of ammonium hydroxide. While having low solubility in water, some magnesium ions form hydroxyl ions in solution, and their build-up prevents further dissociation of the magnesium oxide/hydroxide. The ammonium ions withdraw the hydroxyl ions from the solution, leading to formation of essentially un-ionized ammonium hydroxide (NH₄OH) which, in practice, is in the form of NH₃ and H₂O in solution. The removal of hydroxyl ions in this way fosters the further release into solution of magnesium ions, which in turn will combine with carbonate ions and lead to precipitation of insoluble magnesium carbonate. Thus, ammonia performs a catalytic role insofar as it is not consumed. By selecting these conditions and allowing for detention times of the order of a week, the likelihood of the reaction proceeding to completion is high.

### Catalytic Enhancement by Ammonia

It is observed that the reaction between ‘captured’ carbon dioxide and ultramafic rock may be accelerated if such carbon dioxide is exposed to the rock by first using ammonia to capture the carbon dioxide, thereby converting this to a solution that is rich in, in particular, ammonium bicarbonate, as follows:

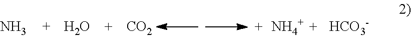

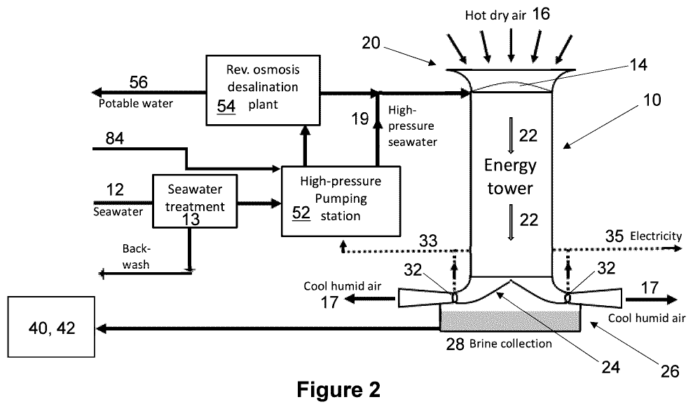

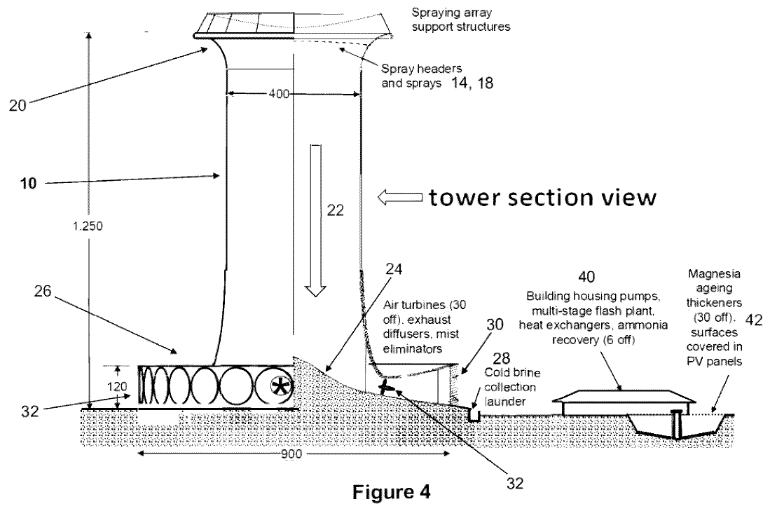

As illustrated in FIGS. 1 to 5, a scrubbing medium: seawater/brine 12 is treated (e.g. screened/filtered) at station 13 and is then passed into a seawater holding basin 50 (FIG. 1). The seawater is drawn from basin 50, via a high-pressure pumping station 52, to be pumped up 19 to a flared upper end 20 of an energy tower 10 (FIGS. 2-4). The seawater is sprayed 14 via a distributor in the form of a spraying system 18 (FIGS. 4 & 5) into the air located in the vicinity of the tower upper end as droplets, mist, etc.

Initially, at commencement, the seawater/brine 12 is dosed with a relatively small percentage of ammonia to serve as the active reagent for extracting carbon dioxide from the air. However, as explained below with reference to the overall continuous, ‘closed-loop’ process of FIG. 1, a recycled ammonia-in-water solution 84 is thereafter mixed with the seawater in pumping station 52, with the combined solution then being sprayed via spraying system 18.

Typically, the air that passes into the open upper end 20 of the energy tower 10 is a hot, dry, CO₂-rich air 16 (FIG. 2)—i.e. as found in the afore-and later-mentioned desert regions of the world. The air leaving the tower is a cool CO₂-lean air stream 17. When the ammonia-containing spray droplets that are sprayed within the tower contact carbon dioxide within the air 16 passing into the tower, they form ammonium bicarbonate (as per reaction 2) above).

To capture ˜90% of the roughly 45 million tonnes of carbon dioxide present in the nominally 108 billion tonnes of air that may be caused to pass through the energy tower each year, reaction 2) requires annually a stoichiometric 15 million tonnes of ammonia be added to the seawater scrubbing medium, making a solution of 1.5% ammonia by weight. Assuming ˜90% of the carbon dioxide passing through the tower reacts with the ammonia, around 70 million tonnes of ammonium bicarbonate will form, yielding a solution concentration of 6.0%, according to reaction 2)—above.

Where the ammonia addition rates are limited/controlled to the stoichiometric quantity, this ensures that the brine (i.e. seawater) solution will remain slightly acidic throughout the tower, hence preventing any slip of ammonia into the air exhausting the tower lower end (e.g. base) of the energy tower.

In the embodiments depicted, some of the aqueous solution comprising ammonia that is charged (i.e. via the spray system 18) into the air located within and adjacent to the energy tower flared, open upper end 20 evaporates. This evaporation serves to cool and humidify the air (which is typically hot, dry ambient desert air when the energy tower is so-located). This makes the air denser, leading to a powerful, reverse-chimney effect with potentially high downdraft velocities. When combined with a relatively large tower diameter, this can yield an immense airflow in the energy tower 10.

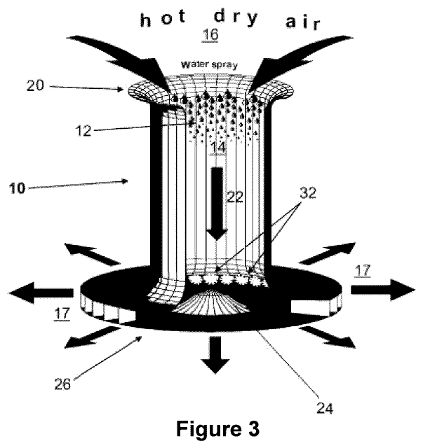

Thus, as illustrated by each of FIGS. 2, 3 & 4, the atmospheric air containing carbon dioxide flows as a stream 22 down through the energy tower 10 along with the aqueous solution comprising ammonia. The high air flow and resulting turbulence (which may include a cyclonic flow component around the tower's central axis) cause the air and aqueous solution to vigorously mix, whereby the carbon dioxide reacts with the ammonia to convert the composition of the droplets to the ammonium bicarbonate solution.

As best illustrated by FIG. 4, the high humidified airflow 22 engages with a convex surface 24 located at the base 26 of the energy tower 10. At least some of the solution present in the ammonium bicarbonate solution will condense/coalesce at the convex (e.g. conical) surface 24 and will thereby flow down to be collected in the under-positioned (FIG. 2) or laterally-positioned (FIG. 4) collection launder 28 located at or surrounding the base 26 of the energy tower 10.

The solution that does not condense/coalesce at surface 24 is eliminated by mist eliminators 30, which are typically located after a bank or series of specially selected gas turbines in the form of air turbines 32 (i.e. so as to preserve as much of the airflow velocity passing to the turbines). The mist eliminators 30 capture remaining airborne ammonium bicarbonate solution from the turbine exhaust and direct it into the collection launder 28.

Typically, the bank of air turbines 32 surround the base 26 of the energy tower 10 (i.e. to generate a maximum amount of electricity). A proportion of this electricity can be fed 33 to the pumping station 52, with the remainder being fed 35 to the main electricity grid.

The collected carbonated brine, held in collection launder 28, concentrated as a result of the water evaporated from it to humidify and cool the ambient air drawn into the tower, is now ready to be mixed and reacted with a metal silicate mineral, such as may be extracted from abundant ultramafic rocks likely to be located in the vicinity of the energy tower. This reaction enables the ammonium bicarbonate in solution to be converted into a more stable and ‘storable’ form. Whilst the mixing of the carbonated brine with the metal silicate mineral can occur in collection launder 28, the reaction is promoted by heat exchange (refer to description of overall process shown in FIG. 1—below).

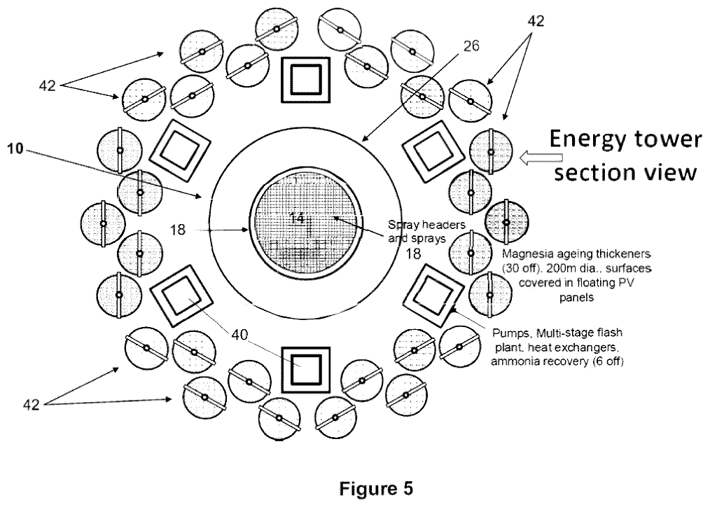

In FIGS. 4 & 5, these reactions are shown as taking place in the multi-stage flash plant and heat exchange facilities 40, and in the magnesia ageing and thickening reactors 42. As shown in FIG. 5, six such facilities 40 are evenly spaced around the base 26 of the energy tower 10, with (in this embodiment) five ageing and thickening reactors 42 being arranged and associated with each of the six facilities 40 (i.e. thirty reactors 42 in total).

Typically, the energy tower 10 is constructed in a hot, dry location noting that metal silicate rocks tend also to be easily accessed in such locations. The locations include the countries surrounding the Arabian sea, northwest Australia, western Sahara, the Kalahari Desert in southern Africa, Baja and Sonora in Mexico, and the Atacama Desert in Chile and Peru.

In the following description, reference to the mineral olivine, the dominant component of the ultramafic rock peridotite, as an example metal silicate will mainly be given, noting that other ultramafic rocks can be employed.

### Carbonation of Ultramafic Rocks

In the next stage of the method and system, the crushed and ground peridotite is added to the carbonated brine collected in the launder 28 (although this addition and mixing may occur in separate mixing tanks/ponds located adjacent to the launder 28). The brine/peridotite mixture (e.g. aqueous slurry) is passed into each of the facilities 40, where the reaction conditions are then optimised. It should be noted that, as part of the reaction, the mineral olivine (Mg₂SiO₄) will show a small tendency to hydrolyse as follows:

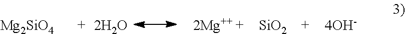

As described earlier the ammonium ions tend to combine strongly with any available hydroxyl ions produced by such hydrolysing to thereby form ammonia and water. It is noted that ammonia and water show little tendency to ionize to form ammonium and hydroxyl ions. This is consistent with the fact that ammonium hydroxide NH₄OH, in reality largely a solution of ammonia in water, is a very weak base, which is to say, the equilibrium for the following reaction 4) is far to the right:

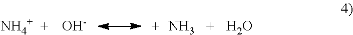

The effect of the equilibrium of reaction 4) being far to the right is to reduce the concentration of hydroxyl ions in solution. This in turn tends to shift the equilibrium of reaction 3) further to the right, prompting more of the olivine to yield its magnesium values into solution (thereby leaving behind insoluble silica). The magnesium ions will tend to associate with the bicarbonate ions from reaction 2) to form magnesium bicarbonate, as follows:

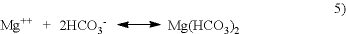

Then, by means to be discussed below, the magnesium bicarbonate is removed from solution by conversion to the essentially insoluble normal carbonate, as follows:

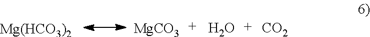

The carbon dioxide formed by reaction 6) is effectively ‘recycled’, i.e. the CO₂ reacts with the ammonia to form more ammonium bicarbonate, hence the CO₂ produced by reaction 6) will feed through the series of reactions above.

Setting out these reactions with consistent quantities, and adding them (resulting in the deletion of the reactants and products in italics) reveals the following reaction series:

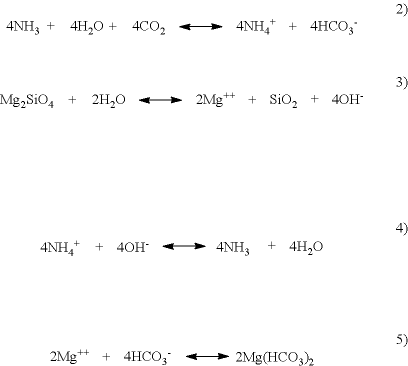

ending with just the reactants, as follows:

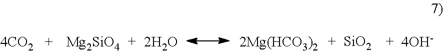

and finally:

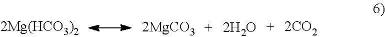

As set forth above, the CO₂ released in reaction 6) reacts with the ammonia as per reaction 2), thereby producing more ammonium bicarbonate, with the bicarbonate ions then associating with the magnesium ions to form more magnesium bicarbonate as per reaction 5).

Ammonia's role in the method and system as disclosed herein can thus be seen as ‘catalytic’, thus it will persist in the system, with the ammonia being recovered for re-use in the energy tower to scrub more CO₂ from the atmospheric air.

It should be noted that reaction 6) represents a simplification. The insoluble compounds first formed from the decomposition of magnesium bicarbonate may be hydrated compounds including the mineral nesquehonite MgCO₃·3H₂O. To convert these compounds to anhydrous magnesite (which will generally be preferred because disposal of nesquehonite and other hydrated forms of magnesium carbonate directly into the ocean is unlikely to be favoured in most settings) the slurry hosting them can be dosed with small magnesite crystals to serve as seeds for their enlargement through Ostwald ripening, while maintaining the slurry at high (i.e. near-boiling) temperatures for as long as several days to weeks.

Once all reactions are complete, reaction 1) remains:

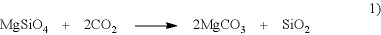

Assuming all reactions as depicted above proceed fully, each tonne of carbon dioxide captured and permanently stored will require stoichiometrically around 1.6 tonnes of pure olivine. But since the olivine will not be pure, and the extraction of magnesium values from the rock may be less than complete, typically around two tonnes of an olivine-rich peridotite (e.g. dunite) is used to capture and store one tonne of carbon dioxide.

### ‘White’ Hydrogen

References so far to peridotite, and its principal component the mineral olivine, include the magnesium end-member Mg₂SiO₄, forsterite. In practice, a significant proportion of the magnesium atoms may be replaced by atoms of (ferrous) iron. The end member of the olivine series in which ferrous atoms alone appear, Fe₂SiO₄, is the mineral fayalite. In nature, a typical olivine may have one ferrous iron atom for every nine magnesium atoms—although this proportion can vary widely. The serpentinization (i.e., the reaction of the mineral with water, typically under high temperatures and pressures) of forsterite, which leads to formation of serpentinite and brucite, has a different outcome with fayalite. In particular, the serpentinization reaction of fayalite yields ferric iron-containing minerals, such as magnetite and goethite; the oxidation of the ferrous iron to ferric, proceeds with the reduction of water to hydrogen:

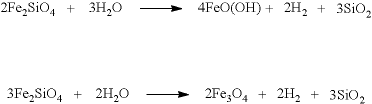

The magnetite formed in the second reaction is a combination of one divalent iron and two trivalent iron atoms.

The resulting hydrogen is referred to as ‘white’ hydrogen. Whilst its production is a natural phenomenon, awareness of its existence in nature is relatively recent, and potential pathways by which it is produced in nature are only now being explored. Because of the relative abundance of peridotites, along with opportunities for them to come into contact with water (serpentinization causes peridotite to swell, leading to formation of cracks and fissures by which water may access new mineral surfaces), many have speculated that vast quantities of white hydrogen are awaiting discovery, and this has prompted many companies and individuals to prospect for it.

Without being bound by theory, it is also thought that white hydrogen can be ‘artificially’ created by way of the above reactions as part of the present process, e.g., when the metal silicate mineral comprises ferrous iron. In such embodiments, the iron present in the metal silicate will have a small tendency to hydrolyse when the metal silicate is in an aqueous solution, forming ferrous ions in solution. In solution, and under the right conditions such as elevated temperature and/or elevated pressure, the ferrous iron can reduce water to hydrogen gas, forming ferric iron in the process, i.e., as in the above reactions.

It is noted that the slightly alkali conditions created by the presence of the ammonium bicarbonate in the slurry will tend to increase the tendency of the iron to be hydrolysed. In addition, the presence of ammonia fosters the further release into solution of magnesium ions. In turn, this facilitates the break-up of the metal silicate, which further increases the rate at which the iron hydrolyses.

It is noted that useful quantities of hydrogen gas can be produced as part of the present process in the course of the reactions between the ground peridotite (in which some of the magnesium atoms are replaced by iron) and the ammonium bicarbonate-rich brine formed in the reactors that form part of the energy tower system. It is also noted that, depending on the amount of iron present in the peridotite, up to 100,000 tonnes per year of white hydrogen can be produced. This amount can be sufficient to manufacture 0.5 million tonnes of ammonia, which is more than sufficient to meet the make-up requirements for ammonia for the energy tower, and to leave a surplus for subsequent sale.

As described in further detail below, ammonia is produced as a byproduct of the reaction between the peridotite slurry and ammonium bicarbonate, in the lower layer of each of the reactor/thickener vessels. Since conditions in this lower layer are maintained at close to boiling point (around 150° C.), once generated, much of the ammonia will be driven from solution as bubbles of gas. These will tend to rise to the top of the lower layer, pass through the layer of spheres serving as a boundary, to enter the upper layer, comprised of fresh seawater. Since this water is at ambient temperatures, the ammonia will immediately dissolve, effecting essentially a recovery of the gas ready for its re-use in the energy tower. Only bubbles of hydrogen will rise to the surface of this upper layer, as the gas is essentially insoluble in water. This hydrogen, along with residual quantities of ammonia are stripped from the reacted slurry, once the reaction below is complete.

### Overall Process (FIG. 1)

A description of an embodiment comprising both the energy tower complex (FIGS. 2 & 3) and the additional plant and equipment required for the capture and storage of carbon dioxide scrubbed from the atmosphere (FIGS. 4 & 5) will now be provided. General reference will be made to the method and system as depicted schematically in the FIG. 1 flowsheet, where like reference numbers denote like parts to those numbers used in FIGS. 2-5, although reference is also made to FIGS. 2-5. FIG. 1 sets out a generic flowsheet for an energy tower-based method and system for storing (as magnesite) carbon dioxide that the energy tower scrubs from the atmosphere.

Initially, suitable sites are selected for the energy tower 10. As set forth above, ideally these are in the world's coastal desert regions which tend to lie between latitudes 20-30 degrees from the equator—e.g. northwest Australia (the Pilbara); Atacama Desert in Northern Chile/Southern Peru, Kalahari Desert in Namibia, Western Sahara, the Sultanate of Oman and other regions around the Arabian Sea stretching to coastal Iran, Pakistan and far-western India (western Gujarat). It is noted that a number of such sites would be out of the world's major flight paths (i.e. for flying altitudes of ˜1 km) hence the construction of one or more massive energy towers in such regions should not represent an aviation hazard. The subtropical inversion level (Hadley inversion) in such areas is typically around one kilometre above sea level but varies daily and seasonally; ideally the energy tower that is constructed at such sites should be tall enough to project well above this inversion layer, into air that is extremely dry for most of the year.

Seawater is accessed and screened at station 13 (see FIG. 2). The screened seawater is pumped to a fresh seawater holding basin 50, ready for use. The basin 50 can comprise a dam that is approximately 25 hectares in area and 10 metres deep. From this basin, water is withdrawn at a rate of around 1.3 billion tonnes per annum. Consistent with reaction 2), to capture 40 million tonnes of carbon dioxide, some 15 million tonnes of ammonia are added to the seawater (roughly 2,000 tonnes per hour), in suitable mixing vessels located in the pumping station 52. When the ammonia-in-seawater solution is pumped from the pumping station 52 to the upper end 20 of the energy tower 10, it forms a solution of approximately 1.3% by weight ammonia in the seawater. The initial ‘seed’ ammonia, as well as top-up ammonia, can be produced in an ammonia plant constructed and located at the site of the energy tower 10.

As the ammonia-in-seawater solution is sprayed into and passes down 22 through the energy tower, its concentration increases (due to evaporation of water) to around 3% at tower base level 26, by which time it will have been converted to 70 million tonnes of ammonium bicarbonate/annum, forming a solution of around 620 million tonnes/annum containing just over 11.5% ammonium bicarbonate by weight along with 8.1% sea salts (mostly sodium chloride).

Assuming annual conditions for the air entering the tower open upper end 20 are 30° C. and 10% relative humidity, in passing through the energy tower 10, and becoming close to saturated (90% relative humidity), the air (and water) are cooled to 15° C., while the quantity of moisture per kilogram of air has tripled, from 0.003 kg/kg dry air, to 0.009 kg/kg dry air, an increase of 0.006 kg/kg dry air. It follows that the 108 billion tonnes of air (3,750 tonnes per second) flowing down the tower would gain approximately 650 million tonnes of water vapour per year, a quantity correspondingly lost by the aqueous phase of the solution.

The pumping task involves the pumping station 52 raising the blended seawater (i.e. plus ammonia) from ground level to the upper end 20 of the energy tower 10 and feeding the solution through a distributor in the form of spraying system 18. Typically, this task is divided between and performed by a total of thirty pumps located in the pumping station 52, each capable of pumping up to 2.0 cubic metres per second against ˜1,300 metres' total head through pipelines nominally 1.0 metres in diameter (3 m/second flow rate). At peak output times, all thirty pumps would be operating to pump the aqueous solution to the upper end 20 of the tower 10, whereas at other times some pumps can send treated seawater to the reverse osmosis desalination facility 54. In the desalination facility 54, half of the water would pass through membranes as desalinated water 56, with the balance 58, complete with nearly all of the dissolved salt in the raw seawater, being pumped to flow to the spraying system 18 located at the upper end 20 of the tower 10.

As set forth above, at the base 26 of the tower 10, prior to final discharge of the CO₂-scrubbed air to the atmosphere, the evaporatively cooled air would be cleaned of any residual brine spray droplets by mist eliminators 30, before being passed to the collection launder 28.

The carbonated brine collected in the collection launder 28 located at or around the base 26 of tower 10, comprised of 520 million tonnes of water, 45 million tonnes of sea-salt and 70 million tonnes of ammonium bicarbonate (all annual figures), and at a temperature typically between 20° C. and 25° C., is dosed 59 with 80 million tonnes per annum of crushed and ground ultramafic rock, typically peridotite, the quantity required to capture 40 million tonnes of carbon dioxide as per reaction 1). As set forth above, the further reaction of the carbonated brine/peridotite is carried out in each of the facilities 40 that are evenly located around the tower 10, where the crushed and ground peridotite (olivine) continues to react with the bicarbonate in the brine.

As set forth above, the crushed and ground peridotite can be mixed with the carbonated brine in each of six blending tanks located in each facility 40 to form a slurry. In other words, the carbonated brine can be pumped from the collection launder 28 to each of six blending tanks located in each facility 40, rather than the peridotite 59 being added to the launder 28 as depicted in FIG. 1.

Prior to entering the reactor/thickener arrays 42 located in each facility 40, the collected brine/peridotite slurry (i.e. each of the six flows) from the energy tower 10 is heated by the exothermic nature of reaction 1). In addition, heat can be transferred to the slurry to raise its temperature to near boiling by passing it through respective heat exchangers 60 associated with each facility 40.

In the embodiment of FIG. 1, each heat exchanger 60 receives therethrough a hot carbonate, ammonia-depleted slurry 62 that is recycled from the multistage flash evaporators of ammonia recovery stage 64. After the recycled slurry 62 heats the brine/peridotite slurry in heat exchanger 60, the cooled brine can either be passed to a solids-liquids separation stage 70 and/or it can be passed 63 directly to the ocean (i.e. where ocean disposal is acceptable/approved).

The resultant heated brine/peridotite slurry (e.g. from each of the six blending tanks and respective heat exchangers 60) is discharged into (in each case) the first of a series of the large reactors 42 that perform the dual function of magnesia ageing and thickening (i.e., carbonation) reactors. In one embodiment, each series of reactors is comprised of three large circular tanks, with the heated slurry discharged into the first reactor in the set of tanks.

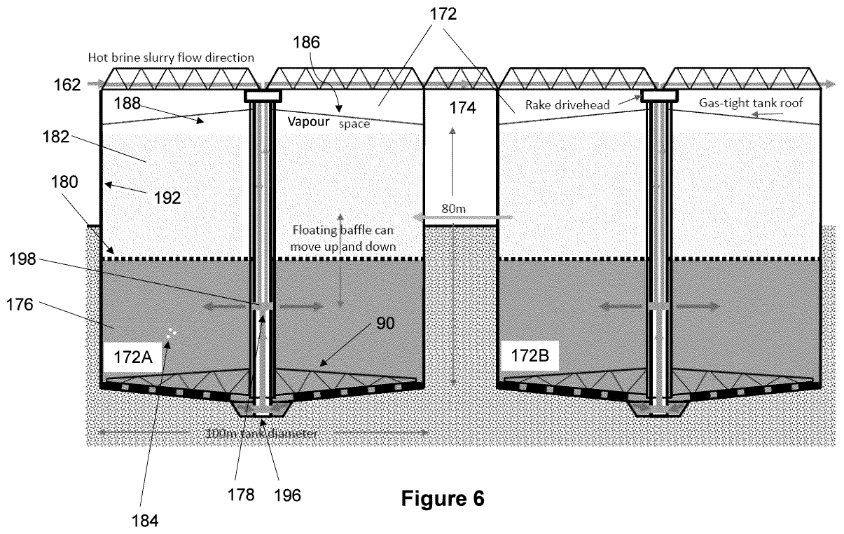

The reactors 42 can comprise the reactor described in detail in the applicant's international application no. WO 2024/103116, the entire contents of which are incorporated herein by way of cross-reference. In this regard, the design and mechanics of all three reactors can be as that described with reference to FIG. 6. In FIG. 6, the large reactors are designated with the reference number 172, with FIG. 6 showing the first two reactors 172A, 172B in a series of three (or more) reactors. The description provided of the first reactor 172A is therefore applicable to all three (or more) reactors in a set.

Whilst each reactor is configured as a reactor/thickener (e.g. a roofed tank reactor of the type shown in FIG. 6), each is also provided with a central column/caisson. Each thickener basin reactor 42 is 100 metres in diameter, and has a centre depth of 80 metres. All tanks are covered to be essentially gas-tight, to allow for the presence of ammonia and hydrogen gas collecting in the vapour space 188 located above the aqueous layer 182 within each reactor/thickener tank.

In normal operation, the contents of each tank is divided into two stacked halves: the two being separated by, in this embodiment, a layer comprised of a large number of air-filled hollow spheres of, e.g. aluminium which have an overall density such that they will float on the relatively higher density (more concentrated, but hotter) slurry occupying the lower level of each vessel, and the lower-density (less concentrated, but cooler) fresh seawater above.

This arrangement provides for an effective slurry capacity (lower level) of 0.3 million cubic metres, sufficient to hold around 1.5 days' output of concentrated brine/peridotite slurry, and a comparable capacity in the upper level of 0.3 million cubic metres. In practice the relative capacities of the two layers may vary, but add up to a combined total of 0.6 million cubic metres. Bridges are provided that span each of the basin reactors to provide access to the centre caisson, and to support interconnecting pipelines, cables and walkways forming the three reactor/thickener basins in each of the total of six groups. The centre caisson supports a rake mechanism which is operated to continuously draw settled solids inwards to the base of the centre caisson.

Referring now to FIG. 6, the heated slurry 162 is fed at 178 into a bottom section of the first reactor (or thickener) 172A and forms a bottom layer 176 within the reactor/thickener. The bottom slurry layer 176 is around 40 metres in depth. The bottom slurry layer 176 is overlayed with a floating baffle 180. The baffle 180 is covered by a top layer 182 of aqueous solution, e.g., seawater, brine, etc.

The seawater is pumped by the pumping station 52 from the basin 50 to each reactor 172. The seawater has an average temperature of 25° C. The top seawater layer 182 maintains a pressure on the bottom slurry layer 176. The height of the seawater layer 182 is approximately 40 metres. This depth is selected to maintain the approximately 4.0 Bar gauge to 5.0 Bar gauge pressure of the bottom brine slurry layer 176, initially imparted by the transfer pumps, but then maintained by the top seawater layer 182.

The floating baffle 180 is configured such that the height of the baffle 180 within the reactor 172A is adjustable. The adjustable height baffle 180 allows the depth of the top layer 182 and the bottom layer 176 to be varied, as the baffle 180 moves up and down with decreased or increased seawater volume. By changing the depth of the top seawater layer 182, the pressure of the bottom slurry layer 176 can be controlled. For example, to increase the pressure, the seawater volume is increased whereby the baffle 180 is lowered, such that the depth of the seawater layer is increased. Every 10 metres of seawater is observed to exert approximately 1 Bar gauge of pressure on the bottom slurry layer 176.

In one embodiment, the baffle 180 comprises around 1.5 million hollow ‘bubbles’, each equivalent to 150 mm diameter. The hollow bubbles are made from 0.25 mm aluminium sheet, each filled with fresh water and sealed, with the hollow bubbles thereby forming a gas-permeable barrier. The baffle 180 has an average height of approximately 0.5 m. The baffle 180 extends across the total horizontal cross-sectional area of the reactor 172A, providing constant separation between the bottom slurry layer 176 and the top seawater layer 182. The effective specific gravity of the aluminium bubbles (being the average of water plus the metal) is approximately 1.1, which is between the specific gravity of the bottom slurry layer 76 (approximately 1.14) and the top seawater layer 182 (approximately 1.03). The baffle 180 allows gases to pass therethrough, from the bottom slurry layer 176 to the top seawater layer 182.

Under the conditions present in the first reactor 172A, the peridotite in the slurry reacts with the ammonium bicarbonate, with the overall reaction resulting in the formation of magnesium carbonate and silica, according to the reaction mechanisms outlined above. In this way, the ammonia used to capture the carbon dioxide in the tower is reproduced for recovery via the series of reactors and the carbon dioxide is sequestered as magnesium carbonate.

The overall reaction by which carbon dioxide and peridotite react is exothermic. Due to the exothermic nature of the reactions, the average temperature of the bottom slurry layer is near-boiling. At a pressure of 4-5 Bar gauge, the average temperature is typically around 140° C., but can be up to 150° C. The heat released by the exothermic reaction maintains these temperatures of between 140 to 150° C. within the bottom slurry layer 176 whilst the slurry is in the reactor 172. The overpressure created by the top seawater layer allows the bottom slurry layer to operate at such high temperatures, without boiling.

The actual reaction pathway is thought to be somewhat nuanced, with the decomposing magnesium bicarbonate likely first forming hydrated magnesium carbonate compounds including the mineral nesquehonite (MgCO₃·3H₂O). To promote the conversion of these compounds to anhydrous magnesite, the slurry can be dosed with small magnesite crystals. The magnesite crystals form as a kind of seed to encourage formation of magnesite in the slurry through Ostwald ripening.

In some embodiments, the magnesium silicate comprises ferrous iron. In such embodiments, the ferrous iron will tend to hydrolyse and form ions within the ammonium bicarbonate slurry. As explained above, the dissolution of ferrous iron is enhanced due to the alkalinity of the slurry. In addition, the break-up of the magnesium silicate is enhanced due to the catalytic effect of the ammonia which, in turn, increases the rate of ferrous iron hydrolysis. Under the conditions within the reactor 172B, the ferrous iron reduces water, thereby forming hydrogen gas and ferric iron.

The ammonia formed by the reactions initially forms bubbles 184 in the bottom slurry layer 176 due to the near-boiling temperature of the bottom slurry layer 176. The ammonia bubbles 184 rise to the top of the bottom slurry layer and pass through the gas-permeable baffle 180. As the ammonia bubbles 184 enter the top seawater layer 182, the ammonia passes into solution, thereby producing a seawater comprising ammonia. The cooler temperature of the top seawater layer 182 helps to promote the dissolution of the ammonia, ensuring that the vapour space 188 in the reactor 172A is almost devoid of ammonia vapour. As a safety-measure, the reactor 172A is fitted with a gas-tight roof 186 to reduce the likelihood of ammonia (and hydrogen) present in the vapour space 188 escaping into the atmosphere.

Similarly, the hydrogen gas (when present) forms bubbles in the bottom slurry layer 176. Because hydrogen gas has a very low density, the bubbles of hydrogen gas will tend to rise through the bottom slurry layer 176, the gas-permeable baffle 180 and into the vapour space 188 of the reactor 172A. Advantageously, because the dissolution of the ammonia within the top seawater layer 182 is promoted, the vapour space 188 will tend to comprise substantially pure hydrogen gas. The hydrogen gas can be collected from the vapour space 188.

To assist the ammonia bubbles 184 and hydrogen (when present) to rise, a rake mechanism 190 at the bottom of the reactor 172A comprises air diffusers which act to mildly aerate the bottom slurry layer 176. The air diffusers produce air bubbles which pass through the bottom slurry layer 176, through the baffle 180 and finally through the top seawater layer 182. The ammonia released by the reactions tends to attach to the air bubbles as they rise, since the transfer of the ammonia to the gas phase is strongly favoured. As the air bubbles pass into the top seawater layer 182, the ammonia contained therein dissolves into the seawater, whilst the air bubbles and hydrogen (when present) tend to pass therethrough.

In some embodiments, the air bubbles can also be controlled so as to maintain oxidising conditions within the slurry. This can ensure that metals, such as iron, which may be present in the slurry are maintained in their more oxidised state. For example, iron is maintained as ferric. However, in other embodiments, the air bubbles can be minimised and/or omitted altogether (e.g. so as not to interfere with ferrous iron hydrolysis). In such embodiments, the rake mechanism 190 may agitate the slurry without diffusing air.

The rake mechanism 190 also facilitates agitation of the slurry within the reactor 172A and movement of the slurry from reactor 172A to reactor 172B. The rake mechanism 190 draws settling slurry inwards towards the bottom centre of the tank 196. The settled slurry is drawn from the bottom centre of the tank 196, into the central caisson 198. From the central caisson 198, a portion of the slurry is pumped back into the bottom layer of reactor 172A, creating agitation within reactor 172A. The remaining portion of the slurry is pumped 174 into the next reactor in the series, in this case reactor 172B. From reactor 172B, the slurry is pumped into a third reactor in the series. The slurry exiting the third reactor comprises the final slurry.

Accordingly, the peridotite slurry forming the bottom slurry layer 176 of each reactor/thickener vessel is agitated by circulating it through the central caissons of the reactor/thickener vessels 42/172, by circulating pumps and high-shear mixers capable of recirculating the contents that have been raked into the centre, and capable of discharging them at (in an embodiment) 10 metres below the surface. As well as circulating the contents within each basin reactor 42/172, the pumps transfer slurry to the next reactor/thickener 42/172 in the series, so that the slurry passes in this way through all three reactor/thickeners 42/172 of the set, taking around five days to transit all three reactor/thickeners. The retention time of five days at elevated temperatures and pressures ensures the reaction between the silicate and ammonium bicarbonate proceeds essentially to completion, to in turn ensure maximal recovery of the ammonia, as well as carbon dioxide being converted to stable magnesium carbonate.

As above, each of the individual ageing and thickening reactors 42/172 is 100 metres in diameter. Each reactor 42/172 has an average depth of 80 metres, with the lower ˜40 metres' depth comprising the ammoniated slurry. This represents an effective 0.3 million cubic metres volume, equivalent to just over 24 hours' production of carbonated brine slurry. The internals of the reactors 42/172 are protected by layers of suitable saltwater-resistant coatings 192, aimed at reducing corrosion.

The seawater is likewise pumped between the three reactors. However, the seawater is pumped in a counter-current direction to the slurry. That is, fresh seawater is added to the third reactor. The seawater can be pre-treated to remove solids and other contaminants (to be handled on a case-by-case basis) likely to cause blockages or otherwise foul downstream surfaces. The seawater from the third reactor is then pumped to reactor 172B. Finally, the seawater from reactor 172B is pumped to reactor 172A. The concentration of ammonia in the seawater progressively increases as the seawater is pumped between the tanks. The seawater exiting reactor 172A can be directly reused in the tower.

In other embodiments, the reactor/thickeners are instead open to the atmosphere and do not comprise an overlaying brine layer. In such embodiments, the reactor/thickeners do not operate under pressure. To minimize evaporation and tendencies for the contents of adjacent reactor/thickeners to mix (i.e. particularly in windy weather), the reactor surfaces (total area of the thirty tanks, one square kilometre) can be covered by shade balls. In another variation, the top covers can be surface can be covered by floating photovoltaic (PV) panels (see e.g. http://latinamericanscience.org/shadeballs-or-floating-solar as an example). While PV panels are more expensive than shade balls, they promise to last longer, and can also generate up to 200 MW of additional useful electricity in clear sunny weather-up to 400 GWh per year (or more if the outer surface of the energy tower were to be coated or formed of a white or otherwise light colour). Since the solar panels will be subject to fallout of brine droplets not collected upstream from the cool air exhaust from the energy tower's air turbine diffusers 30, the panels can be washed periodically (e.g. daily) using desalinated water produced in reverse osmosis facility 54. An advantage of washing the panels with desalinated water is that a layer of water of lower density than the brine/peridotite slurry can form and overlay on the latter, serving as a thermal insulating layer and thereby trapping heat in the slurry, while also keeping the PV panels cool.

By holding the brine plus peridotite plus ammonium bicarbonate slurry at close to the boiling point of water for ˜five day's detention time, the reactor/thickeners 42/172 can allow these reactions to proceed to completion, with the outcome being as per the right-hand side of reaction 1). Seed crystals of magnesium carbonate can be added to encourage crystal growth of the latter compound, at the expense of nesquehonite and similar hydrated magnesite crystals, i.e. by the process of Ostwald ripening:

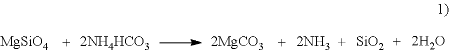

Only after completing passage through all three thickener/reactors 42/176 of each set (of which there are six operating in parallel in the facilities 40), is the hot slurry withdrawn from the reactors. As set forth above, such a procedure may take several days. Much of the ammonia will have been stripped as it is boiled out of the hot slurry to be captured in the cool seawater of the upper layer, while the hydrogen produced will accumulate in the head-space over the upper layer in the reactor/thickener vessels. In the embodiment of FIG. 1, the hot slurry withdrawn from the carbonation reactors 42 is passed to a multi-stage flash distillation (i.e. ammonia separation) facility 64. In facility 64, the remaining ammonia is distilled off from the slurry, typically being progressively distilled off in the flash evaporator: the hot slurry is boiled successively (i.e. by stages) under increasingly reduced pressures, whereupon the ammonia contained in the slurry is stripped out by the water vapour that is also produced.

The hot (ammonia-depleted) slurry that is produced in the distillation facility 64 is then passed through the heat exchanger 60 to exchange its heat with the brine/peridotite slurry incoming to reactors 42. As set forth above, the now-cooled, ammonia-depleted slurry can be passed to the ocean, or it can be diverted to the solids-liquids separation facility 70.

In the solids-liquids separation facility 70, the now thick, carbonated mineral slurry of magnesium carbonate (MgCO₃), along with silica (SiO₂) and other insoluble solids, is separated as stream 72 from a cooled aqueous brine solution 66. The solids are in essence inert, making them suitable for disposal in a variety of different ways. The clarified brine solution 66 produced is suitable for passing directly back to the ocean from whence it originated.

The solids-liquids separation facility 70 employs conventional solids-liquids separation stages, including a pair of 120-metre diameter thickeners in each facility 40 that yield a dense slurry of magnesite-rich solids. This slurry (typically in paste form) is pumped away to the designated emplacement site, representing a volume after evaporation of surplus water of some 80 million cubic metres per annum. The design of such an emplacement would take into consideration local disposal options.

For example, the substantially cooled, spent paste 72 can be discharged for disposal as landfill, such as at the mine site from which the metal silicate (peridotite) mineral was mined. Some of the paste 72 can also be emplaced in playas on land where these are within ˜200 kilometres of the facility. In this regard, the essentially inert slurry can be thickened in the thickeners 70 to varying degrees (e.g. to turn the solids into a pumpable slurry or paste which is then pumped to e.g. the mine site, playa, etc.).

However, should there be a proliferation of such energy tower-based systems, the cooled, spent (i.e. ammonia-depleted) slurry/paste 72 may instead be disposed of in the deep ocean (i.e. option 63 in FIG. 1), to join the much-larger quantities of inert sediments entering the oceans from the natural weathering of rocks and soils on land world-wide. When the total slurry is discharged to the ocean, there may be no need for thickening of the slurry in the thickeners. Further, when the total slurry is discharged to the ocean, the magnesium carbonate has the added benefit of neutralising ocean acidification according to:

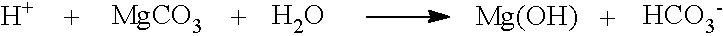

Also, in the distillation facility 64, the mixed ammonia-water vapour can be condensed on cooling pipes. These cooling pipes can have flowing therethrough the cool, raw carbonated brine that is collected from the base of the energy tower (i.e. that is to be held in the collection launder 28). This cool, raw carbonated brine is at or below ambient temperatures, and thus the ammonia and water vapour that condenses on the cooling pipes can thereby heat this raw carbonated brine, ready for its reaction with the metal silicate (peridotite). Such heating can thereby represent a heat input into the raw carbonated brine to enhance its reaction with the peridotite. The water-ammonia solution 76 from the condensation of the respective vapours is typically somewhat dilute but can be returned to the energy tower 10 in this form, to add to that directly recovered in the upper, fresh seawater layers of the reactor/thickener vessels for dosing into the seawater at the pumping station 52.

However, FIG. 1 also shows an option of a fractionating facility 80 in which the relatively dilute water-ammonia solution 76 is fractionated to yield additional fresh water 82 and a more concentrated ammonia-water solution 84.

In this way, up to 98% of the ammonia may be recovered for re-use in the energy tower 10. However, this still means that around 300,000 tonnes per year of ammonia is required as make-up, the hydrogen for which may be drawn from white hydrogen production or, if this option cannot be used, it can be made in a natural gas-fired ammonia plant, requiring in turn around 150,000 tonnes per year of natural gas. Such ammonia can readily be made according to the familiar Haber-Bosch Process.

When the method and system as disclosed herein employ a reagent other than ammonia (e.g. ammonium ions, such as an ammonium salt in aqueous solution; an oxide/hydroxide pairing, such as an aqueous solution comprising the same (e.g. an oxide/hydroxide pairing based on magnesium and/or calcium and/or lithium, etc.); amines such as the alkylamines and alkanolamines DEA, ETA/MEA, and MDEA; inorganic solvents such as alkaline solvents; etc.) then, to convert the CO₂-reagent reaction product into a form that is suitable for storage, a cheap and abundant material (e.g. mineral) is selected that can react with the CO₂-reagent reaction product. For at least the ammonium ion, oxide/hydroxide pairing, and alkaline solvents, the ultramafic rocks referred to herein may be suitable.

Where reagents other than ammonia are employed, the slurry that is withdrawn from the carbonation reactors 42/172 may instead be passed to a solids-liquids or other type of separation facility for separation and recovery of the reagent.

As set forth above, another suitable reagent is magnesium hydroxide, with an aqueous solution of magnesium hydroxide being made according to the process as outlined in WO 2017/106923 (the relevant contents of which are incorporated herein by reference).

In an embodiment, magnesia (MgO) is added (typically under agitation) to the seawater 12, usually prior to (although it can be added in) the high-pressure pumping station 52, such as in a suitable mixing tank. The MgO may readily be produced using the Mg₂SiO₄ as outlined above. In this regard, the Mg₂SiO₄ may be acid leached and/or thermally decomposed to produce MgO.

Sufficient time is allowed for a good proportion of the magnesium oxide to convert to magnesium hydroxide (i.e. according to reaction (a) above). The resultant seawater/Mg(OH)₂ solution is then pumped under high pressure to the open upper end 20 of the energy tower 10 and is then sprayed into the incoming hot dry airstream 16 via the spray headers 18.

The heat and turbulence of the resultant mix of hot dry airstream 16 and spray droplets of the seawater/Mg(OH)₂ solution, along with the height of the energy tower, is sufficient for the seawater/Mg(OH)₂ solution to react with and convert a proportion of the CO₂ present in the airstream 16 (i.e. according to reactions (b) to (d) above) into magnesium carbonate and bicarbonate (i.e. MgCO₃ and Mg(HCO₃)₂).

To increase the proportion of the carbonate (MgCO₃) produced, the resultant solution that is separated at convex surface 24 and eliminators 30 can be aged in the thickening reactors 42/172. Additionally, a proportion of the ageing solution can be recycled to the spray system 14 for respraying into the incoming hot dry airstream 16 via the spray headers 18.

Once a sufficient extent of conversion of magnesium hydroxide to magnesium carbonate has been achieved, the resultant total seawater/magnesium carbonate slurry can be returned to the ocean without attempting to separate the solids from the liquid. Here, it is noted that vast quantities of magnesium carbonate are already added to the oceans via the natural weathering of exposed ultramafic rocks. Further, the alkalinity of magnesium carbonate (and including any un-reacted magnesium hydroxide and magnesium bicarbonate) would work to offset increased ocean acidity.

It should be understood that electricity generation apparatus other than (or in conjunction with) gas turbines may be employed in the tower to harness the kinetic energy of the downwards stream. For example, wind turbines (e.g. horizontal axis windmills located within the tower, vertical axis wind turbines arranged at a downstream outlet from the tower, etc.).

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features.

1. A process for producing hydrogen from a magnesium silicate that comprises ferrous iron, the process comprising:
mixing an aqueous solution that comprises ammonium ions with the magnesium silicate that comprises ferrous iron to form an ammoniated slurry;
subjecting the ammoniated slurry to reaction conditions by which the ferrous iron is caused to be released from the magnesium silicate and such that released ferrous iron reduces water, thereby forming hydrogen gas and ferric iron.

2. The process according to claim 1, wherein the aqueous solution comprises ammonium bicarbonate.

3. The process according to claim 2, wherein the reaction conditions further comprise conditions by which the ammonium bicarbonate reacts with the magnesium silicate to form a magnesium carbonate and silica slurry, and whereby ammonia is released.

4. The process according to claim 3, the process further comprising overlaying the ammoniated slurry with an aqueous layer to create a top aqueous layer and a bottom ammoniated slurry layer, whereby the ammonia that is released from the bottom ammoniated slurry layer is able to pass into the top aqueous layer to thereby produce an aqueous solution comprising ammonia.

5. The process according to claim 4, wherein the hydrogen gas is able to pass through the top aqueous layer to be collected in a gas space located above the top aqueous layer.

6. The process according to claim 1, wherein the reaction conditions comprise elevated temperatures and/or elevated pressures.

7. The process according to claim 6, wherein the elevated temperature is below the boiling point of water at the elevated pressure.

8. The process as claimed in claim 6, wherein an elevated pressure of the ammoniated slurry is generated by overlaying the ammoniated slurry with a top aqueous layer.

9. The process according to claim 6, wherein the ammoniated slurry is subjected to an elevated temperature of about 150° C. and an elevated pressure ranging from about 4.0 to about 5.0 Bar gauge.

10. The process according to claim 1, wherein the magnesium silicate that comprises ferrous iron comprises one or more of: olivine, enstatite, serpentinite, peridotite, dunite, harzburgite, lherzolite, wehrlite, forsterite, fayalite.

11. The process according to claim 2, wherein the aqueous solution comprising ammonium bicarbonate is produced by scrubbing a gas stream with an aqueous solution comprising ammonia to remove carbon dioxide from the gas stream.

12. The process according to claim 11, wherein the aqueous solution comprising ammonium bicarbonate is produced in a process which comprises:
enabling atmospheric air to pass into an upper end of an elongate hollow tower, wherein the elongate hollow tower has a lower end and a height measured from the upper end to the lower end;
charging the aqueous solution comprising ammonia so as to mix with atmospheric air within and adjacent to the elongate hollow tower upper end in a manner such that the air is cooled by evaporative cooling, whereby the mixture passes downwards as a stream through the elongate hollow tower, and the aqueous solution comprising ammonia reacts with the carbon dioxide to form the aqueous solution comprising ammonium bicarbonate.

13. The process according to claim 12, the process further comprising generating electricity from the downwards stream that is passing through the elongate hollow tower, wherein the electricity is generated from the downwards stream by passing it through one or more gas turbines that are configured to generate electricity.

14. The process according to claim 12, the process further comprising separating the aqueous solution comprising ammonium bicarbonate from the downwards stream, said separated solution being reacted with the metal silicate to form a magnesium carbonate and silica slurry, and to release ammonia back into the solution for recovery and reuse in the elongate hollow tower.

15. The process according to claim 14, wherein the carbon dioxide produced as a result of reacting the ammonium bicarbonate with the metal silicate is collected and reacted with the aqueous solution that comprises ammonia to form more ammonium bicarbonate, able to react with additional metal silicate.

16. The process according to claim 14, wherein the metal carbonate and other insoluble solids are separated from the aqueous solution, with the aqueous solution being recycled to recover ammonia for re-use in the elongate hollow tower.

17. The process according to claim 16, wherein prior to said separation, the process further comprises heating of an aqueous slurry that comprises the metal carbonate and other insoluble solids, the heating being conducted to distil off the ammonia present in the solution, with the distilled off ammonia along with distilled off water being collected and condensed to form an ammonia-in-water solution, which solution is recycled to the elongate hollow tower.

18. The process according to claim 12, wherein the upper end of the elongate hollow tower is open, and wherein the aqueous solution is charged as droplets or mist into the air within and adjacent to the elongate hollow tower open upper end whereby, as the mixture passes downwards as a stream through the elongate hollow tower, more atmospheric air is caused to pass into the elongate hollow tower open upper end to mix with aqueous solution being charged into and adjacent to the elongate hollow tower upper end.

19. The process according to claim 1, wherein the aqueous solution comprises seawater or other brine.

20. The process according to claim 4, wherein the aqueous layer that overlays the ammoniated slurry comprises seawater or other brine.
